(19) United States
(12) Patent Application Publication
(10) Pub. No.: US 2025/0299429 A1
(43) Pub. Date: Sep. 25, 2025

(54) IMAGE GENERATION APPARATUS AND METHOD

(71) Applicant: SAMSUNG ELECTRONICS CO., LTD., Suwon-si (KR)

(72) Inventors: Seungbin OH, Suwon-si (KR); Sangyoon LEE, Suwon-si (KR); Youngah LEE, Suwon-si (KR); Sungjun HWANG, Suwon-si (KR)

(73) Assignee: SAMSUNG ELECTRONICS CO., LTD., Suwon-si (KR)

(21) Appl. No.: 19/065,873

(22) Filed: Feb. 27, 2025

Related U.S. Application Data
(63) Continuation of application No. PCT/KR2025/001840, filed on Feb. 7, 2025.

(30) Foreign Application Priority Data
Mar. 21, 2024 (KR) 10-2024-0039101

(51) Int. Cl. G06T 15/20; G06T 5/70; G06T 7/50

(52) U.S. Cl. CPC G06T 15/205; G06T 5/70; G06T 7/50; G06T 2200/24; G06T 2210/21

(57) ABSTRACT

An image generation apparatus includes a display, an input device, memory storing instructions, and at least one processor, where the instructions, when executed by the at least one processor, cause the image generation apparatus to receive, through the input device, a user input selecting at least one two-dimensional (2D) image and at least one three-dimensional (3D) space type, provide a 3D image based on the selected at least one 2D image and the selected at least one 3D space type, and control the display to display the provided 3D image.

### CROSS-REFERENCE TO RELATED APPLICATIONS

This application is a continuation of International Application No. PCT/KR2025/001840, filed on Feb. 7, 2025, in the Korean Intellectual Property Receiving Office, which is based on and claims priority to Korean Patent Application No. 10-2024-0039101, filed on Mar. 21, 2024, in the Korean Intellectual Property Office, the disclosures of which are incorporated by reference herein in their entireties.

### BACKGROUND

### 1. Field

The disclosure relates to an image generation apparatus and method for generating a three-dimensional (3D) image.

### 2. Description of Related Art

When a user changes a background screen of a desktop, laptop, or mobile device, various images may be used, such as images provided by a manufacturer, images provided by a content provider, or images acquired by the user.

A light field display (LFD) is a three-dimensional (3D) display that creates a stereoscopic image by generating a light field expressed as a vector distribution (intensity, direction) of light in a space by a flat display and optical elements. To set a background screen of such an LFD monitor, a 3D image for 3D environment may be required.

Such 3D images are not easy for users to create themselves, and 3D images provided by, for example, manufacturers, are limited. Accordingly, there is an increasing need for users to convert desired images into 3D images and set the images as a background screen of the LFD monitor.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Provided are an image generation apparatus and method that may be capable of generating a three-dimensional (3D) image based on a two-dimensional (2D) image to enable a user to easily obtain the 3D image desired by the user.

Additional aspects will be set forth in part in the description which follows and, in part, will be apparent from the description, or may be learned by practice of the presented embodiments.

According to an aspect of the disclosure, an image generation apparatus may include a display, an input device, memory storing instructions, and at least one processor, where the instructions, when executed by the at least one processor, cause the image generation apparatus to receive, through the input device, a user input selecting at least one 2D image and at least one 3D space type, generate a 3D image based on the selected at least one 2D image and the selected at least one 3D space type, and control the display to display the generated 3D image.

The instructions, when executed by the at least one processor, may cause the image generation apparatus to identify distinct layers of a plurality of objects in the generated 3D image, and where the distinct layers may have different depth levels.

The plurality of objects may include a first object on a first layer having a first depth level and a second object on a second layer having a second depth level that is higher than the first depth level, and the instructions, when executed by the at least one processor, may cause the image generation apparatus to generate the 3D image by generating an image corresponding to an area where the second object is obscured due to the first object overlapping the second object.

The instructions, when executed by the at least one processor, may further cause the image generation apparatus to blur the second object at a first blur effect level, and control the display to display the blurred second object.

The plurality of objects may include a third object on a third layer having a third depth level that is higher than the second depth level, and the instructions, when executed by the at least one processor, may cause the image generation apparatus to control the display to blur the third object at a second blur effect level that is higher than the first blur effect level, and control the display to display the blurred third object.

The instructions, when executed by the at least one processor, may further cause the image generation apparatus to control the display to sequentially display the plurality of objects based on depth levels of respective layers on which the plurality of objects are positioned.

The plurality of objects may include a user interface (UI) object on a fourth layer having a fourth depth level that is higher than the first depth level and lower than the second depth level, and the instructions, when executed by the at least one processor, may further cause the image generation apparatus to blur the second object and control the display to display the blurred second object.

The instructions, when executed by the at least one processor, may further cause the image generation apparatus to, based on receiving a user input associated with moving the UI object to a fifth layer having a fifth depth level that is lower than the first depth level, control the display to display the UI object moving to the fifth layer.

The instructions, when executed by the at least one processor, further cause the image generation apparatus to, based on the UI object reaching the first layer, apply a collision effect to the first object and the UI object, and control the display to display the first object and the UI object to which the collision effect is applied.

Wherein the instructions, when executed by the at least one processor, cause the image generation apparatus to generate the 3D image by positioning the selected at least one 2D image on a 2D development shape corresponding to the selected at least one 3D space type and transforming the 2D image positioned on the 2D development shape into a 3D shape corresponding to the selected at least one 3D space type.

According to an aspect of the disclosure, an image generation method may include receiving a user input selecting a 2D image, receiving a user input selecting a 3D space type, generating a 3D image based on the selected 2D image and the selected 3D space type, and displaying the generated 3D image.

The method may include identifying distinct layers having different depth levels among a plurality of objects in the generated 3D image, the plurality of objects may include a first object on a first layer having a first depth level and a second object on a second layer having a second depth level that is higher than the first depth level, and the generating of the 3D image may include generating an image corresponding to an area where the second object is obscured due to the first object overlapping the second object.

The displaying of the 3D image may include blurring the second object at a first blur effect level, and outputting the blurred second object.

The plurality of objects may include a third object on a third layer having a third depth level that is higher than the second depth level, and the displaying of the 3D image may include blurring the third object at a second blur effect level that is higher than the first blur effect level, and displaying the blurred third object.

The displaying of the 3D image may include sequentially displaying the plurality of objects based on depth level of respective layers on which the plurality of objects are positioned.

The plurality of objects may include a UI object on a fourth layer having a fourth depth level that is higher than the first depth level and lower than the second depth level, and the method may include burring the second object and displaying the blurred second object.

The method may include, based on receiving a user input associated with moving the UI object to a fifth layer having a fifth depth level that is lower than the first depth level, displaying the UI object moving to the fifth layer.

The method may include, based on the UI object reaching the first layer applying a collision effect to the first object and the UI object, and displaying the first object and the UI object to which the collision effect is applied.

The generating the 3D image may include positioning the selected at least one 2D image on a 2D development shape corresponding to the selected at least one 3D space type and transforming the 2D image positioned on the 2D development shape into a 3D shape corresponding to the selected at least one 3D space type.

According to an aspect of the disclosure, a non-transitory computer-readable storage medium may store instructions that, when executed by at least one processor, cause an image generation apparatus to receive a user input selecting a 2D image, receive a user input selecting a 3D space type, generate a 3D image based on the selected 2D image and the selected 3D space type, and display the generated 3D image.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of an image generation apparatus according to one or more embodiments of the disclosure;

FIG. 2 is a flowchart illustrating a three-dimensional (3D) image generation method according to one or more embodiments of the disclosure;

FIG. 3 is a diagram illustrating an example of a two-dimensional (2D) image and 3D space type according to one or more embodiments of the disclosure;

FIGS. 4 to 6 are diagrams illustrating processes for generating a 3D image based on a 3D space type according to one or more embodiments of the disclosure;

FIG. 7 is a flowchart illustrating processes of generating a 3D image by segmenting layers of objects according to one or more embodiments of the disclosure;

FIG. 8 is a diagram illustrating processes of generating a 3D image by segmenting layers of objects according to one or more embodiments of the disclosure;

FIG. 9 is a diagram illustrating displaying, to a user, a 3D image generated by segmenting layers of objects according to one or more embodiments of the disclosure;

FIG. 10 is a flowchart illustrating processes of blurring an object positioned on a layer of a high depth level according to one or more embodiments of the disclosure;

FIG. 11 is a diagram illustrating a difference in a degree of blur effect based on layers of objects according to one or more embodiments of the disclosure;

FIG. 12 is a diagram illustrating a user interface (UI) object placed together in a 3D image according to one or more embodiments of the disclosure;

FIG. 13 is a flowchart illustrating a collision interaction based on movement of an UI object according to one or more embodiments of the disclosure; and

FIG. 14 is a diagram illustrating a collision interaction based on movement of an UI object according to one or more embodiments of the disclosure.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The term “and/or” includes any and all combinations of one or more of the associated listed items.

Terms such as “1st”, “2nd”, “primary”, or “secondary,” etc. may be used simply to segment an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

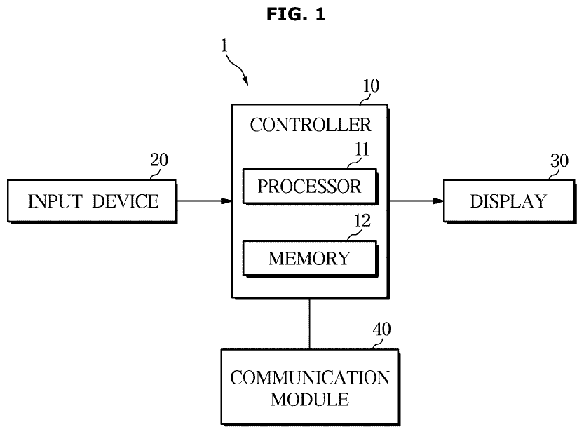

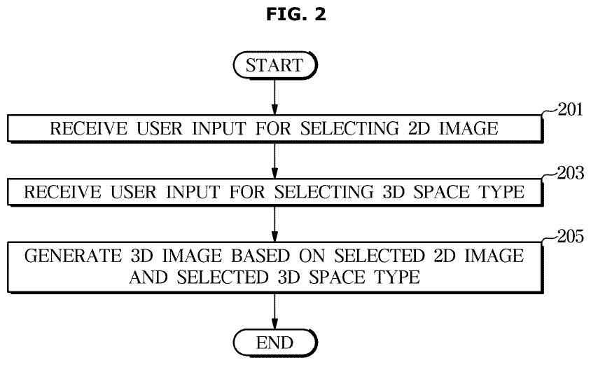

FIG. 1 is a block diagram of an image generation apparatus according to one or more embodiments of the disclosure. FIG. 2 is a flowchart illustrating a three-dimensional (3D) image generation method according to one or more embodiments of the disclosure.

The image generation apparatus 1 may include an input device 20, a controller 10, and a display 30, and the controller 10 may include a processor 11 and a memory 12.

The controller 10 may include a memory 12 that stores a control program and control data for generating a 3D image and controlling the display to output the 3D image, as well as at least one processor 11 that generates a control signal according to the control program and control data stored in the memory 12. The memory 12 and the processor 11 may be provided integrally or separately. The controller 10 (e.g., via the processor 11) may execute instructions (e.g., that are stored in the memory 12) to cause the image generation apparatus to perform the functions described herein.

The memory 12 may store at least one 2D image and at least one 3D space type, and may store a program (e.g., instructions) and data for generating a 3D image and controlling the display to output the 3D image.

The memory 12 may include a volatile memory for temporarily storing data, such as a static random access memory (RAM) (SRAM) and a dynamic RAM (DRAM). In addition, the memory 12 may include a non-volatile memory such as a read only memory (ROM), erasable programmable ROM (EPROM), and electrically erasable programmable ROM (EEPROM) for long-term data storage.

The processor 11 may include logic circuits and operation circuits, may process data according to the program stored in the memory, and may generate a control signal based on the processing result.

The processor 11 may generate a 3D image based on a selected two-dimensional (2D) image and a selected 3D space type in operation 205.

The processor 11 may input the single 2D image to an artificial intelligence (AI) model to generate the 3D image. Here, the AI model may include a generative AI.

In one or more embodiments, the AI model may be stored in the memory 12 and/or an external device (e.g., a server).

In a case where the AI model is stored in the memory 12, the processor 11 may generate the 3D image by inputting the selected 2D image and the selected 3D space type to the AI model stored in the memory 12.

In a case where the AI model is stored only in the external device, the processor 11 may transmit information about the selected 2D image and the selected 3D space type to the external device through a communication module 40. The external device may generate a 3D image by inputting the selected 2D image and the selected 3D space type to the AI model, and may transmit the generated 3D image to the image generation apparatus 1. As a result, the processor 11 may generate the 3D image.

That is, the operation of generating the 3D image by inputting the selected 2D image and the selected 3D space type to the AI model by the processor 11 may include the operation of the processor 11 generating the 3D image by inputting the selected 2D image and the selected 3D space type to the AI model stored in the memory 12, and/or the operation of the processor 11 generating the 3D image by transmitting the information about the selected 2D image and the selected 3D space type to the external device that stores the AI model through the communication module 40 and receiving the generated 3D image from the external device.

The communication module 40 may include at least one of a short-range wireless communication module or a long-range wireless communication module.

The communication module 40 may transmit data to an external device (e.g., a server, a user device, etc.) or receive data from the external device. For example, the communication module 40 may establish communication with a server and/or a user device, and transmit and receive data.

For the communication, the communication module 40 may establish a direct (e.g., wired) communication channel or a wireless communication channel between external devices, and support the performance of the communication through the established communication channel. According to one or more embodiments, the communication module 40 may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5^{th} generation (5G) network, a next-generation communication network, the Internet, or a computer network (e.g., LAN or wide area network (WAN)). These various types of communication modules may be integrated as one component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+ communication module, a microwave (uWave) communication module, etc., but is not limited thereto.

For such communication modules, there may be a first communication module for communicating with a server and a second communication module for communicating with a user device or the like, or a single communication module may perform communication with both the server and the user device, or the like.

The input device 20 may receive an input from, for example, a user or the like (hereinafter referred to as ‘a user’) for selecting a 2D image and a 3D space type from among at least one 2D image and at least one 3D space type stored in the memory 12, in operations 201 and 203, respectively. A method of implementing the input device 20 is not limited thereto, and the input device 20 may be implemented in various forms for receiving input from a user. The input device 20 may receive an input from a user for selecting a single 2D image and a single 3D space type, or a selection of multiple 2D images and multiple 3D space types, and combinations thereof. Then, based on the selections of the 2D image and the 3D space type, the processor 11 may generate a 3D image in operation 205.

For example, the input device 20 may include a tact switch, a push switch, a slide switch, a toggle switch, a micro switch, a touch switch, a touch pad, a touch screen, a jog dial, and/or a microphone.

In addition, a user input may be received from a separate device, such as a remote control, through a second communication module.

The input device 20 may also receive a voice input from a user.

In this case, the input device 20 may be implemented as a microphone, and the like, to directly receive a voice input from a user, but a voice input through a microphone of an external device, such as a remote control, may also be received by the communication module 40.

The display 30 may output the 3D image generated by the processor 11. The display 30 may include various types of displays capable of outputting a 3D image, such as a monitor of a desktop or a screen of a mobile device.

In one or more embodiments, the image generation apparatus 1 may not include the display 30, and may be connected to a separate external device to allow a display provided in the external device to output the generated 3D image.

That is, the image generation apparatus 1 may be connected to a separate external device, such as a television (TV) or monitor (wired or wirelessly connected), to allow the 3D image generated by the image generation apparatus 1 to be output from the external device.

In this case, the image generation apparatus 1 may be provided with a separate output port for outputting a video/audio signal of the generated 3D image to the external device. That is, the image generation apparatus 1 may be provided with a video signal output port for outputting the video signal and an audio signal output port for outputting the audio signal separately or together in one port.

The image generation apparatus 1 may transmit the video/audio signal to the external device through a communication module 40 via wireless communication, and the like.

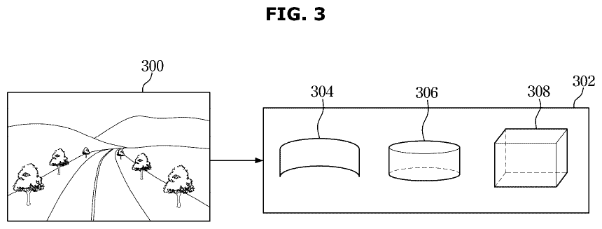

FIG. 3 is a diagram illustrating an example of 2D image and 3D space types according to one or more embodiments of the disclosure.

As described above, a user may select a 2D image 300 and a 3D space type through the input device 20.

The user may select a 2D image stored in the memory, or may upload a 2D image taken by the user or acquired by any another method and select the uploaded 2D image.

In addition, the user may select one of at least 3D space type stored in the memory.

The 3D space types 302 may include, for example, a curved type 304, a cylinder type 306, and a cube type 308. These 3D space types 302 are only examples and may include different 3D space types.

The processor 11 may generate a 3D image based on the 2D image 300 and 3D space type 302 selected by the user.

The process of generating a 3D image for each of the types described above as an example is described below.

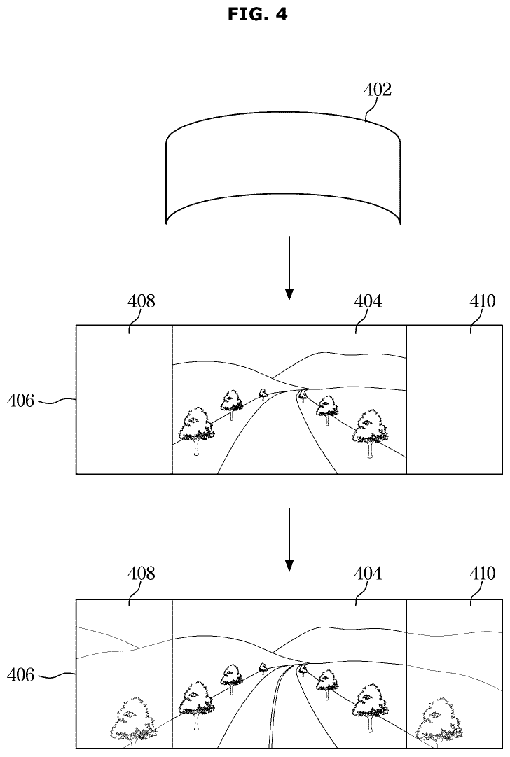

FIGS. 4 to 6 are diagrams illustrating processes for generating a 3D image based on a 3D space type according to one or more embodiments of the disclosure.

Referring to FIG. 4, the processor 11 may generate a 3D image of a curved type based on the curved type 402 selected from the 3D space types.

In a case where the curved type 402 is selected, the processor 11 may position the selected 2D image 404 on a 2D development shape 406 corresponding to the selected 3D space type 402.

Thereafter, the processor 11 may generate an image for a remaining area 408 and 410 not occupied by the 2D image 404 in the 2D development shape 406 using an AI model (e.g., a generative AI model), to allow the generated image to be integrated with the 2D image.

That is, in a case where the existing 2D image 404 is placed on the development shape 406 corresponding to the curved type 402, the left and right areas 408 and 410 of the 2D image may not be filled by the existing 2D image 404 and may be empty.

In this instance, an image for the empty areas 408 and 410 not filled by the existing 2D image 404 may be generated to enable the generated image to be seamlessly integrated with the existing 2D image 404.

In this regard, the AI model may recognize images (visual understanding). The visual understanding of the AI model is a technology that recognizes and processes objects in a manner similar to human vision, and may include object recognition, object tracking, image search, face recognition, scene understanding, spatial understanding, and image enhancement.

In the case of a 2D image 404 including trees and mountains, etc., as shown in FIG. 4, the processor 11 may generate an image that fills the empty areas 408 and 410 with trees and mountains to smoothly blend with the existing 2D image 404.

As described above, the processor 11 may input the 2D image 404 to the generative AI model to generate the images for the remaining areas 408 and 410, or the processor 11 may directly generate the images for the remaining areas 408 and 410 as the generative AI model.

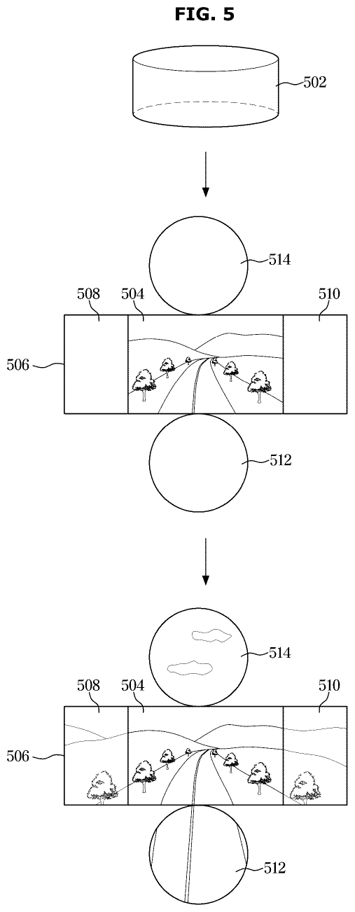

Referring to FIG. 5, the processor 11 may generate a 3D image of a cylinder type based on the cylinder type 502 selected from the 3D space types.

In a case where the cylinder type 502 is selected, the processor 11 may position the selected 2D image 504 on a 2D development shape 506 corresponding to the selected 3D space type 502.

Thereafter, the processor 11 may generate an image for a remaining area 508 and 510 not occupied by the 2D image 504 in the 2D development shape 506 using the generative AI model to allow the generated image to be integrated with the 2D image 504.

That is, in a case where the existing 2D image 504 is placed on the development shape 506 corresponding to the cylinder type 502, the left/right areas 508 and 510, as well as upper/lower areas 512 and 514 of the 2D image may not be filled by the existing 2D image 504 and may be empty.

In this instance, an image for the empty areas 508, 510, 512 and 514 not filled by the existing 2D image 504 may be generated to enable the generated image to be seamlessly integrated with the existing 2D image 504.

In the case of a 2D image 504 including trees, mountains, roads, sky, and the like, as shown in FIG. 5, the processor 11 may generate an image that fills the empty areas 508, 510, 512 and 514 with trees, mountains, roads, sky, and the like so as to smoothly blend with the existing 2D image.

Specifically, the processor 11 may generate an image to allow the generated image to be seamlessly integrated with the trees and mountains in the left/right areas 508 and 510 of the 2D image, and generate an image to allow the generated image to be seamlessly integrated with the sky in the upper area 514 of the 2D image, and generate an image to allow the generated image to be seamlessly integrated with the road in the lower area 512 of the 2D image.

As described above, the processor 11 may input the 2D image 504 to the generative AI model to generate the images for the remaining areas 508, 510, 512 and 514, or the processor 11 may directly generate the images for the remaining areas 508, 510, 512 and 514 as the generative AI model.

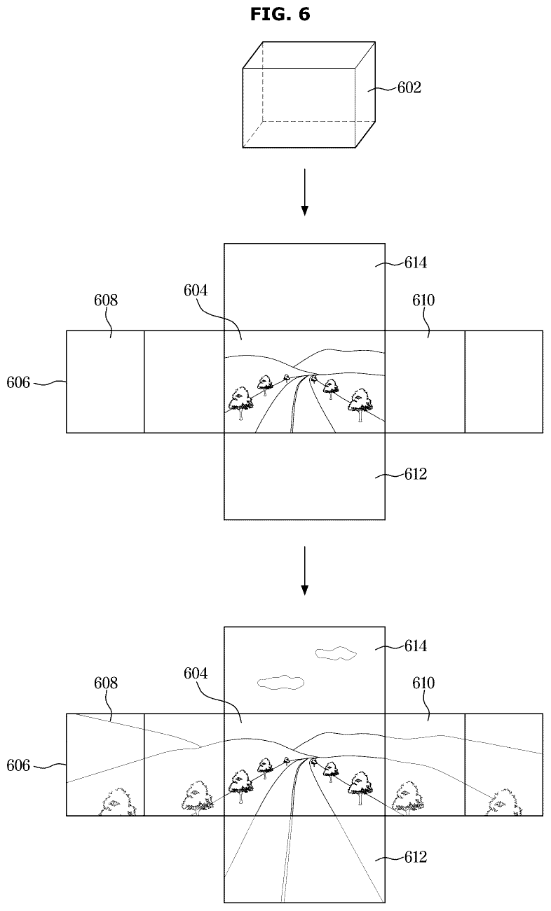

Referring to FIG. 6, the processor 11 may generate a 3D image of a cube type based on the cube type 602 selected from the 3D space types.

In a case where the cube type 602 is selected, the processor 11 may position the selected 2D image 604 on a 2D development shape 606 corresponding to the selected 3D space type 602.

Thereafter, the processor 11 may generate an image for a remaining area 608, 610, 612 and 614 not occupied by the 2D image 604 in the 2D development shape 606 using the generative AI model to allow the generated image to be integrated with the 2D image 604. That is, in a case where the existing 2D image 604 is placed on the development shape 606 corresponding to the cube type 602, the left/right areas 608 and 610, as well as the upper/lower areas 612 and 614 of the 2D image may not be filled by the existing 2D image 604 and may be empty.

In this instance, an image for the empty areas 608, 610, 612 and 614 not filled by the existing 2D image 604 may be generated to enable the generated image to be seamlessly integrated with the existing 2D image 604.

In the case of a 2D image 604 including trees, mountains, roads, sky, and the like, as shown in FIG. 6, the processor 11 may generate an image that fills the empty areas 608, 610, 612 and 614 with trees, mountains, roads, sky, and the like so as to smoothly blend with the existing 2D image 604.

Specifically, the processor 11 may generate an image to allow the generated image to be seamlessly integrated with the trees and mountains in the left/right areas 608 and 610 of the 2D image, and generate an image to allow the generated image to be seamlessly integrated with the sky in the upper area 614 of the 2D image, and generate an image to allow the generated image to be seamlessly integrated with the road in the lower area 612 of the 2D image.

As described above, the processor 11 may input the 2D image 604 to the generative AI model to generate the images for the remaining areas 608, 610, 612 and 614, or the processor 11 may directly generate the images for the remaining areas 608, 610, 612 and 614 as the generative AI model.

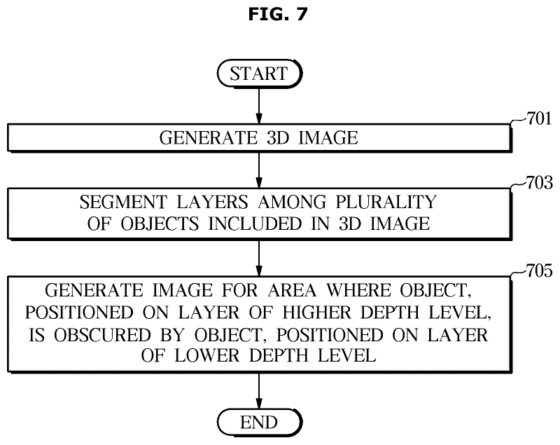

FIG. 7 is a flowchart illustrating processes of generating a 3D image by segmenting layers of objects according to one or more embodiments of the disclosure.

As described above, the processor 11 may generate a 3D image based on a selection of a 2D image and a 3D space type in operation 701.

Thereafter, the processor 11 may segment layers among a plurality of objects included in the generated 3D image in operation 703.

That is, the layers among the plurality of objects may be segmented to provide a three-dimensional effect to a user.

For example, the plurality of objects may include a first object positioned on a first layer and a second object positioned on a second layer having a higher depth level than the first layer.

Here, each layer may have a different depth level in the 3D image. For example, the plurality of objects may include four objects. The first object may be in a first layer at a first level, the second object may be in a second layer at a second level higher than the first level, the third object may be in a third layer at a third level higher than the second level, and the fourth object may be in a fourth layer at a fourth level higher than the third level.

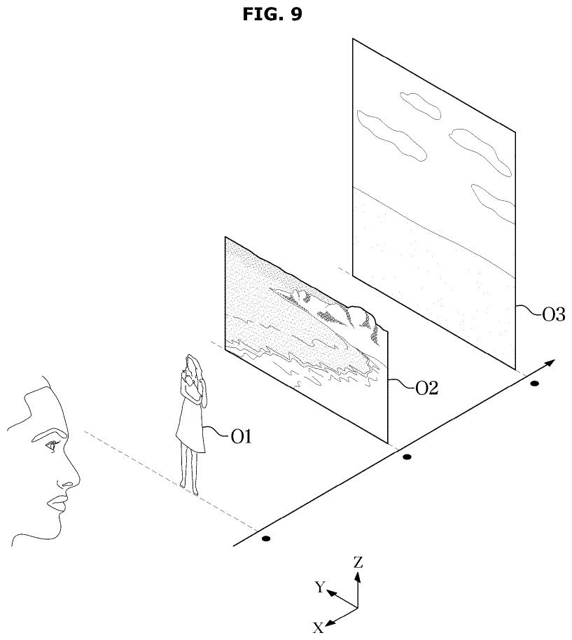

That is, from a user's viewpoint, the layer that is further back in the 3D image may have a higher depth level, and a layer located further forward in the 3D image may have a lower depth level. The lower depth level may refer to a depth level that is closer to the user's view and the higher depth level may refer to a depth level that is further from the user's view. For example, referring to FIG. 9, the object O1 may be at a first level, the object O2 may be at a second level, and the object O3 may be at a third level. The first level may be the lowest depth level (i.e., least amount of depth from the user's perspective or closest to the user's perspective), and the third level may be the highest depth level (i.e., most amount of depth from the user's perspective or farthest away from the user's perspective).

The processor may control the display to sequentially display the plurality of objects according to a depth level of a respective layer where each of the plurality of objects is positioned.

The processor 11 may generate an image for an area where the second object is obscured by the first object overlapping the second object to allow the generated image to be seamlessly integrated with an image of an unobscured area of the second object.

That is, processor 11 may generate an image for an area where an object, positioned on a layer of a higher depth level, is obscured by an object, positioned on a layer of a lower depth level in operation 705. Thus, this may allow the generated image to be seamlessly integrated with an image of an unobscured area of the object positioned on the layer of higher depth level.

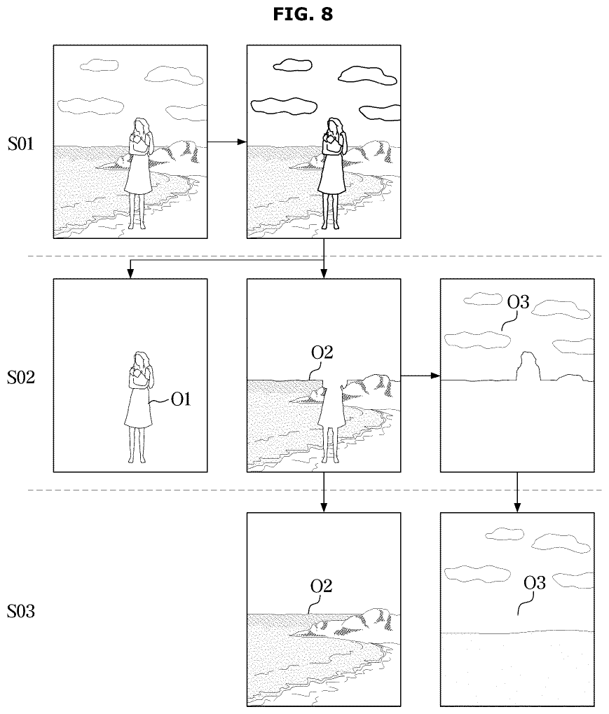

The detailed description thereof is described with reference to FIG. 8.

FIG. 8 is a diagram illustrating processes of generating a 3D image by segmenting layers of objects according to one or more embodiments of the disclosure. FIG. 9 is a diagram illustrating displaying, to a user, a 3D image generated by segmenting layers of objects according to one or more embodiments of the disclosure is displayed to a user.

In operation S01, the processor 11 may segment layers of a plurality of objects included in a generated 3D image. That is, the processor 11 may segment an object positioned on a layer of a relatively low depth level and an object positioned on a layer of a relatively high depth level. As shown in operation S01, the human-shaped object and the sky-shaped may be segmented based on the depth levels as compared to the beach-shaped objects.

Thereafter, in operation S02, the processor 11 may separate the segmented objects. That is, the processor 11 may separate the objects into a human-shaped object O1 positioned on the layer of the lowest depth level, a beach-shaped object O2 positioned on the layer of a higher depth level than that of the human-shaped object O1, and a sky-shaped object O3 positioned on the layer of the highest depth level.

Thereafter, in operation S03, the processor 11 may generate an image for an area where the object on the higher depth-level layer is obscured by the object on the lower depth-level layer to allow the generated image to be seamlessly integrated with an image of an unobscured area with respect to each of the separated objects.

Specifically, in the case of the beach-shaped object O2, the processor 11 may generate an image for an obscured area of the beach-shaped object O2, i.e., the area covered by the human-shaped object O1 positioned on a lower depth-level layer, so as to allow the generated image to fill in the obscured area of the beach-shaped object O2. Accordingly, the empty area caused by the human-shaped object O2 in the beach-shaped object O2 may be filled, thereby enabling the entire beach-shaped object O2 to be displayed.

Also, in the case of the sky-shaped object O3, the processor 11 may generate an image for an obscured area of the sky-shaped object O3, i.e., the area covered by the human-shaped object O1 and the beach-shaped object O2 positioned on the lower depth-level layers, so as to allow the generated image to fill in the obscured area of the sky-shaped object O3. Accordingly, the empty area caused by the human-shaped object O2 and the beach-shaped objects O3 in the sky-shaped objects O3 may be filled, thereby enabling the entire sky-shaped object O3 to be displayed.

By arranging the generated images according to the layers, a 3D image that may provide a user with a stereoscopic effect may be generated, as shown in FIG. 9.

That is, when the user looks at a monitor, etc., the 3D image may be generated to make the user feel as if the human-shaped object O1 is in the front, the beach is behind the object O1, and the sky is behind the beach.

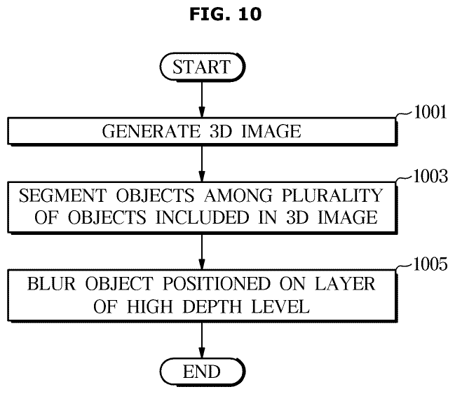

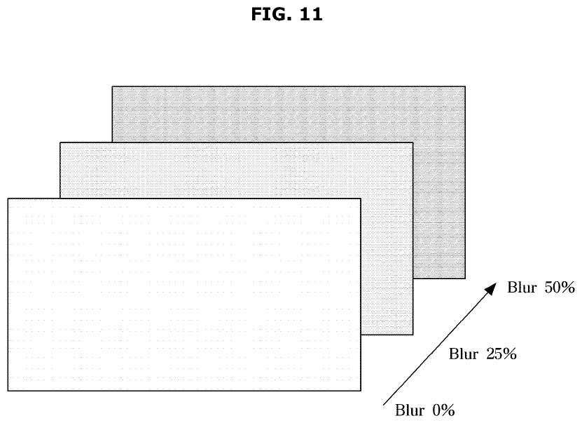

FIG. 10 is a flowchart illustrating processes of blurring an object positioned on a layer of a high depth level according to one or more embodiments of the disclosure. FIG. 11 is a diagram illustrating a difference in a degree of blur effect based on layers of objects according to one or more embodiments of the disclosure.

In operation 1001, the device may generate a 3D image. In operation 1003, the device may segment objects among a plurality of objects included in the 3D image. That is, as described in FIG. 8, objects may be segmented from other objects based on their depth levels (e.g., based on their corresponding depth layer). In operation 1005, the device may blur an object positioned on a layer having a high depth level (i.e., further back from the user's perspective) relative to other objects in the 3D image.

In order to improve a visibility of a 3D image, the processor 11 may blur an object positioned on a layer having a relatively high depth level.

That is, in the case of a 3D image including a first object positioned on a first layer and a second object positioned on a second layer having a higher depth level than the first layer as described above, the second object positioned relatively farther back from the user's viewpoint may be blurred to make the first object positioned in the front more visible, thereby providing an effect of improved visibility and three-dimensionality.

The processor 11 may control the display 30 to output the blurred second object, i.e., the second object to which the blur effect is applied.

In a case where a third object positioned on a third layer having a higher depth level than the second layer is further included, the processor 11 may blur the third object at a higher blur level than the second object.

That is, as shown in FIG. 11, visibility and three-dimensionality may be further improved by applying a higher level of blur effect to an object positioned on a layer having a higher depth level.

Referring to FIG. 9 as an example, without blurring the human-shaped object O1 positioned on the layer having the lowest depth level, the beach-shaped object O2 may be blurred at a blur level of approximately 25%, and the sky-shaped object O3 positioned on the layer having the highest depth level may be blurred at a higher blur level of approximately 50%. The above blur levels, i.e., blur effect levels, are only examples, and may be set to different levels to improve visibility and three-dimensionality.

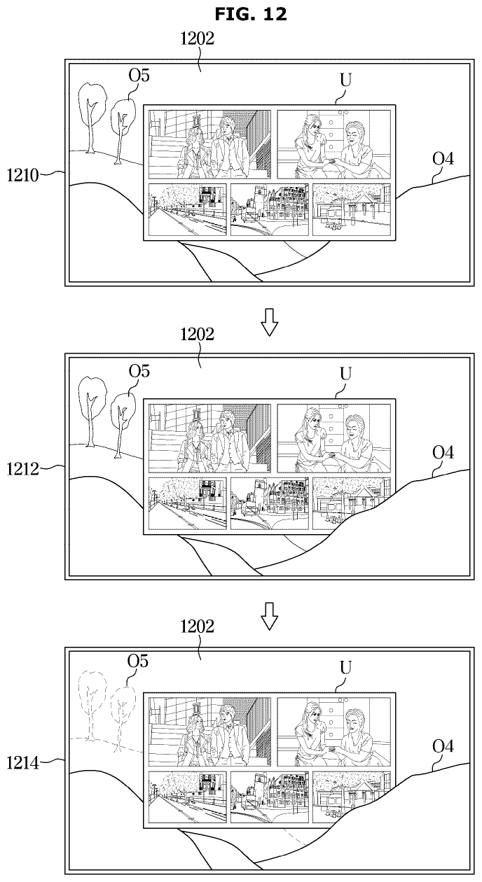

FIG. 12 is a diagram illustrating a user interface (UI) object placed together in a 3D image according to one or more embodiments of the disclosure.

A UI object U may be placed within a background screen of a computer, and the like. In this case, a relationship between a plurality of objects and the UI object U within a 3D image is described below.

In a 3D image including a first object positioned on a first layer and a second object positioned on a second layer having a higher depth level than the first layer as described above, a UI object positioned on a fourth layer having a higher depth level than the first layer and a lower depth level than the second layer may be further included.

In this case, the processor 11 may blur the second object positioned on a layer having a higher depth level than the UI object U, and may control the display 30 to output the blurred second object, i.e., the second object to which the blur effect is applied.

That is, by blurring the object positioned relatively farther back than the UI object U, visibility of the UI object U may be improved.

As shown in FIG. 12, a 3D image 1202 may be provided. The 3D image 1202 may include the UI object U, a fourth object O4 corresponding to hills, and a fifth object O5 corresponding to trees. The 3D image 1202 may be provided in a first form 1210. Then, the processor 11 may identify a depth layer of the object O4 and a depth layer of an object O5. In this case, the depth layer of object O4 is a lower depth layer than the depth layer of the object O5. Thus, the UI object U is presented on a first depth layer of a first depth level, the object O4 is presented on a second depth layer of a second depth level that is higher than the first depth level, and the object O5 is presented on a third depth layer of a third depth level that is higher than the second depth level, in first form 1210.

In the second form 1212, the processor 11 may identify that depth level of the UI object U is to be changed. That is, the processor 11 may identify to change the depth level (or the user may select an operation to change the depth level) of the UI object U. Thus, the depth level of the UI object in second form 1212 is changed, such that the object O4 is presented on the second depth layer at the second depth level, the UI object U is moved to a fourth depth layer of a fourth depth level that is higher than the second depth level but is lower than the third depth level of the object O5. Thus, object O4 appears to be in front of the UI object U.

Then, in the third form 1214, the processor 11 may determine to blur object O5, as object O5 is at the highest depth level.

An AI model or the like may be used to place the UI object U in an appropriate position to improve a user's visibility.

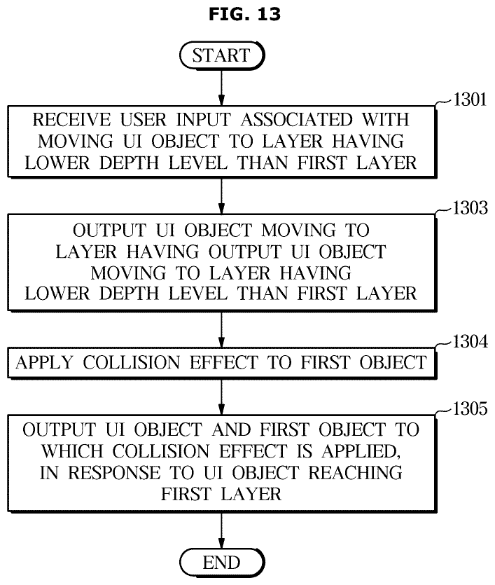

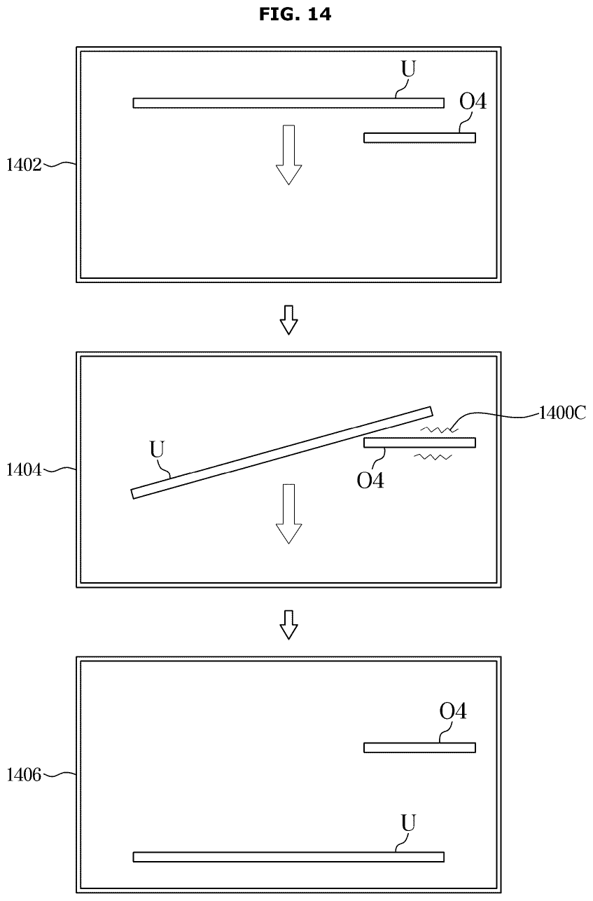

FIG. 13 is a flowchart illustrating a collision interaction based on movement of an UI object according to one or more embodiments of the disclosure. FIG. 14 is a diagram illustrating a collision interaction based on movement of an UI object according to one or more embodiments of the disclosure.

In a 3D image including a first object positioned on a first layer and a second object positioned on a second layer having a higher depth level than the first layer as described above, in a case where a UI object U positioned on a fourth layer having a higher depth level than the first layer and a lower depth level than the second layer is further included, the processor 11 may receive a user input associated with moving the UI object to a layer having a lower depth level than the first layer in operation 1301, and control the display 30 to output the UI object moving to a layer having a lower depth level than the first layer in operation 1303. In operation 1304, the processor 11 may apply a collision effect to the first object based on the movement of the UI object to another layer.

Thereafter, in response to the UI object reaching the first layer, the processor 11 may control the display 30 to output the first object and the UI object to which a collision effect is applied in operation 1305.

That is, as shown in FIG. 12, in a case where the mountain-shaped object O4 positioned on a lower depth-level layer than the UI object U and the object O5 positioned on a higher depth-level layer than the UI object U are included, in response to receiving a user input to move the UI object to a lower depth-level layer than the mountain-shaped object O4 (e.g., operation 1301), the processor 11 may move the UI object to the lower depth-level layer than the mountain-shaped object O4.

Thereafter, when the UI object U reaches the same layer as the layer where the mountain-shaped object O4 is positioned during the movement of the UI object, the processor 11 may apply a collision effect to the UI object U and the mountain-shaped object O4 (e.g., operation 1304) and may control the display 30 to output the UI object U and the mountain-shaped object O4 to which the collision effect is applied (e.g., operation 1305).

As shown in FIG. 14, in operation 1402 when a UI object U is positioned at a higher depth level than that of object O4, a user input may be received to move the UI object U relative to the object O4 positioned on a lower depth-level layer than the UI object U. The user input may be a motion, such as a gesture of a user's hand, or an input using a separate device such as a mouse.

In operation 1404, while moving the position of the UI object U to the lower depth level layer according to such a gesture, in a case where the UI object U overlaps with the object O4 positioned on the lower depth-level layer than the UI object U, the processor 11 may apply the collision effect 1400C to the UI object U and the object O4.

For example, various types of collision effects may be applied, such as processing the object O4 positioned on the lower depth level layer than the UI object U to vibrate, processing the object O4 and the UI object U to move forward and then move backward, or processing the UI object U to be partially tilted by the object O4 and then return to its original shape. By applying such collision effects, the user may feel a sense of liveliness.

In operation 1406, the UI object U may have been moved to a depth level that is higher than the depth level of the object O4.

According to one or more embodiments of the disclosure, an image generation apparatus may include a memory configured to store at least one 2D image and at least one 3D space type, a input device configured to receive a user input for selecting one of the at least one 2D image and one of the at least one 3D space type stored in the memory, a processor configured to generate a 3D image based on the selected 2D image and the selected 3D space type, and a display configured to output the generated 3D image.

According to one or more embodiments, a 3D image may be generated based on a 2D image to enable a user to easily obtain the 3D image desired by the user.

The distinct layers may have different depth levels.

The plurality of objects may include a first object positioned on a first layer, and a second object positioned on a second layer having a higher depth level than the first layer, and the processor may be configured to generate an image for an area where the second object is obscured by the first object overlapping the second object to allow the generated image to be seamlessly integrated with an image of an unobscured area of the second object.

The processor may be configured to blur the second object, and control the display to output the blurred second object.

The plurality of objects may further include a third object positioned on a third layer having a higher depth level than the second layer, and the processor may be configured to control the display to output the third object to which a higher level of blur effect is applied than to the second object.

The processor may be configured to control the display to sequentially display the plurality of objects according to a depth level of a respective layer where each of the plurality of objects is positioned.

The plurality of objects may further include a UI object positioned on a fourth layer having a higher depth level than the first layer and a lower depth level than the second layer, and the processor may be configured to blur the second object positioned on the second layer having a higher depth level than the fourth layer, and control the display to output the blurred second object.

The processor may be configured to, in response to receiving a user input associated with moving the UI object to a layer of a lower depth level than the first layer, control the display to output the UI object moving to the layer of the lower depth level than the first layer based on the user input.

The processor may be configured to control the display to output the first object and the UI object to which a collision effect is applied, in response to the UI object reaching the first layer.

The processor may be configured to generate the 3D image by positioning the selected 2D image onto a 2D development shape corresponding to the selected 3D space type and transforming the 2D image of the 2D development shape into a 3D shape corresponding to the selected 3D space type.

According to one or more embodiments of the disclosure, an image generation method may include receiving a user input for selecting a 2D image, receiving a user input for selecting a 3D space type, generating a 3D image based on the 2D image corresponding to the received user input and the 3D space type corresponding to the received user input, identifying distinct layers having different depth levels among a plurality of objects included in the generated 3D image, and outputting the generated 3D image.

The plurality of objects may include a first object positioned on a first layer, and a second object positioned on a second layer having a higher depth level than the first layer, and the generating of the 3D image may include generating an image for an area where the second object is obscured by the first object overlapping the second object to allow the generated image to be seamlessly integrated with an image of an unobscured area of the second object.

The outputting of the 3D image may include blurring the second object, and outputting the blurred second object.

The plurality of objects may include a third object positioned on a third layer having a higher depth level than the second layer, and the outputting of the 3D image may include outputting the third object to which a higher level of blur effect is applied than to the second object.

The outputting of the 3D image may include sequentially displaying the plurality of objects according to a depth level of a respective layer where each of the plurality of objects is positioned.

The plurality of objects may further include a UI object positioned on a fourth layer having a higher depth level than the first layer and a lower depth level than the second layer, and the outputting of the 3D image may include blurring the second object positioned on the second layer having a higher depth level than the fourth layer, and outputting the blurred second object.

The outputting of the 3D image may include, in response to receiving a user input associated with moving the UI object to a layer of a lower depth level than the first layer, outputting the UI object moving to the layer of the lower depth level than the first layer based on the user input.

The outputting of the 3D image may include outputting the first object and the UI object to which a collision effect is applied, in response to the UI object reaching the first layer.

The generating of the 3D image may include generating the 3D image by positioning the selected 2D image onto a 2D development shape corresponding to the selected 3D space type and transforming the 2D image of the 2D development shape into a 3D shape corresponding to the selected 3D space type.

According to one or more embodiments, the image generation apparatus and method may generate a 3D image based on a 2D image to enable a user to easily obtain the 3D image desired by the user.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to one or more embodiments, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one or more embodiments, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. An image generation apparatus, comprising:
a display;
an input device;
memory storing instructions; and
at least one processor;
wherein the instructions, when executed by the at least one processor, cause the image generation apparatus to:
receive, through the input device, a user input selecting at least one two-dimensional (2D) image and at least one three-dimensional (3D) space type;
provide a 3D image based on the selected at least one 2D image and the selected at least one 3D space type; and
control the display to display the provided 3D image.

2. The image generation apparatus of claim 1, wherein the instructions, when executed by the at least one processor, cause the image generation apparatus to identify distinct layers of a plurality of objects in the provided 3D image, and
wherein the distinct layers have different depth levels.

3. The image generation apparatus of claim 2, wherein the plurality of objects comprise:
a first object on a first layer having a first depth level; and
a second object on a second layer having a second depth level that is higher than the first depth level, and
wherein the instructions, when executed by the at least one processor, cause the image generation apparatus to provide the 3D image by generating an image corresponding to an area where the second object is obscured due to the first object overlapping the second object.

4. The image generation apparatus of claim 3, wherein the instructions, when executed by the at least one processor, further cause the image generation apparatus to:
blur the second object at a first blur effect level; and
control the display to display the blurred second object.

5. The image generation apparatus of claim 4, wherein the plurality of objects further comprise a third object on a third layer having a third depth level that is higher than the second depth level, and
wherein the instructions, when executed by the at least one processor, cause the image generation apparatus to control the display to:
blur the third object at a second blur effect level that is higher than the first blur effect level; and
control the display to display the blurred third object.

6. The image generation apparatus of claim 5, wherein the instructions, when executed by the at least one processor, further cause the image generation apparatus to control the display to sequentially display the plurality of objects based on depth levels of respective layers on which the plurality of objects are positioned.

7. The image generation apparatus of claim 3, wherein the plurality of objects further comprise a user interface (UI) object on a fourth layer having a fourth depth level that is higher than the first depth level and lower than the second depth level, and
wherein the instructions, when executed by the at least one processor, further cause the image generation apparatus to:
blur the second object; and
control the display to display the blurred second object.

8. The image generation apparatus of claim 7, wherein the instructions, when executed by the at least one processor, further cause the image generation apparatus to, based on receiving a user input associated with moving the UI object to a fifth layer having a fifth depth level that is lower than the first depth level, control the display to display the UI object moving to the fifth layer.

9. The image generation apparatus of claim 8, wherein the instructions, when executed by the at least one processor, further cause the image generation apparatus to, based on the UI object reaching the first layer:
apply a collision effect to the first object and the UI object; and
control the display to display the first object and the UI object to which the collision effect is applied.

10. The image generation apparatus of claim 1, wherein the instructions, when executed by the at least one processor, cause the image generation apparatus to provide the 3D image by positioning the selected at least one 2D image on a 2D development shape corresponding to the selected at least one 3D space type and transforming the 2D image positioned on the 2D development shape into a 3D shape corresponding to the selected at least one 3D space type.

11. An image generation method comprising:
receiving a user input selecting a two-dimensional (2D) image;
receiving a user input selecting a three-dimensional (3D) space type;
providing a 3D image based on the selected 2D image and the selected 3D space type; and
displaying the provided 3D image.

12. The image generation method of claim 11, further comprising identifying distinct layers having different depth levels among a plurality of objects in the provided 3D image,
wherein the plurality of objects comprise:
a first object on a first layer having a first depth level; and
a second object on a second layer having a second depth level that is higher than the first depth level, and
wherein the providing of the 3D image comprises providing an image corresponding to an area where the second object is obscured due to the first object overlapping the second object.

13. The image generation method of claim 12, wherein the displaying of the 3D image comprises blurring the second object at a first blur effect level, and outputting the blurred second object.

14. The image generation method of claim 13, wherein the plurality of objects further comprise a third object on a third layer having a third depth level that is higher than the second depth level, and
wherein the displaying of the 3D image comprises blurring the third object at a second blur effect level that is higher than the first blur effect level, and displaying the blurred third object.

15. The image generation method of claim 14, wherein the displaying of the 3D image comprises sequentially displaying the plurality of objects based on depth level of respective layers on which the plurality of objects are positioned.

16. The image generation method of claim 13, wherein the plurality of objects further comprise a user interface (UI) object on a fourth layer having a fourth depth level that is higher than the first depth level and lower than the second depth level, and
wherein the method further comprises:
burring the second object; and
displaying the blurred second object.

17. The image generation method of claim 16, further comprising, based on receiving a user input associated with moving the UI object to a fifth layer having a fifth depth level that is lower than the first depth level, displaying the UI object moving to the fifth layer.

18. The image generation method of claim 17, further comprising, based on the UI object reaching the first layer:
applying a collision effect to the first object and the UI object; and
displaying the first object and the UI object to which the collision effect is applied.

19. The image generation method of claim 11, wherein the providing the 3D image comprises positioning the selected at least one 2D image on a 2D development shape corresponding to the selected at least one 3D space type and transforming the 2D image positioned on the 2D development shape into a 3D shape corresponding to the selected at least one 3D space type.

20. A non-transitory computer-readable storage medium storing instructions that, when executed by at least one processor, cause an image generation apparatus to:
receive a user input selecting a two-dimensional (2D) image;
receive a user input selecting a three-dimensional (3D) space type;
provide a 3D image based on the selected 2D image and the selected 3D space type; and
display the provided 3D image.
